(19) United States
(12) Patent Application Publication
(10) Pub. No.: US 2014/0040257 A1
(43) Pub. Date: Feb. 6, 2014

(54) DASHBOARD VIEWS OF TASK ACTIVITY

(71) Applicant: Rajesh Chandrasekaran, Arlington, MA (US)

(72) Inventor: Rajesh Chandrasekaran, Arlington, MA (US)

(73) Assignee: CA, Inc., Islandia, NY (US)

(21) Appl. No.: 13/562,878

(22) Filed: Jul. 31, 2012

(51) Int. Cl. G06F 17/30

(52) U.S. Cl. 707/736; 707/E17.005

(57) ABSTRACT

Various embodiments illustrated and described herein provide include at least one of systems, methods, and software providing dashboard views of task activity data. Some embodiments include servicing dashboard view requests by retrieving a dashboard configuration that identifies at least one chart template of a chart to be included in the dashboard view and identifying user and activity data to populate respective charts generated based on the respective at least one chart templates. Such embodiments further include retrieving each of the at least one chart template and the respective user and user activity data to populate respective at least one chart. The retrieved chart templates are then processed to incorporate the respective user and user activity data into a respective chart rendering generated based thereon, and each chart rendering is added to a dashboard view data structure which may then be transmitted to a requestor for viewing.

### BACKGROUND INFORMATION

The present disclosure relates to data presentation, and more specifically to dashboard view of task activity.

Many systems in modern computing environments involve performance of tasks that are performed by different individuals and groups of individuals. For example, user credential management involves many tasks including credential provisioning, role management, policy management, and the like. Tasks to be performed are typically initially received as requests that may involve several included tasks to be performed by one or more administrative personnel to whom the included tasks are assigned. As there can be many tasks to be performed by different functional groups of administrative personnel, monitoring and management of task performance and request fulfillment can be complex and time consuming, especially in view of the size and distributed nature of many large, multinational organizations.

### BRIEF SUMMARY

Various embodiments illustrated and described herein provide include at least one of systems, methods, and software providing dashboard views of task activity data. One such embodiment, in the form of a method, includes servicing dashboard view requests by retrieving a dashboard configuration that identifies at least one chart template of a chart to be included in the dashboard view and identifying user and activity data to populate respective charts generated based on the respective at least one chart templates. Such embodiments further include retrieving each of the at least one chart template and the respective user and user activity data to populate respective at least one chart. The retrieved chart templates are then processed to incorporate the respective user and user activity data into a respective chart rendering generated based thereon, and each chart rendering is added to a dashboard view data structure that may then be transmitted to a requestor for viewing.

### BRIEF DESCRIPTION OF THE DRAWINGS

Aspects of the present disclosure are illustrated by way of example and are not limited by the accompanying figures with like references indicating like elements.

FIG. 1 is a logical block diagram of a system, according to an example embodiment.

FIG. 2 is a dashboard view user interface illustration, according to an example embodiment.

FIG. 3 is a dashboard view user interface illustration, according to an example embodiment.

FIG. 4 is a block flow diagram of a method, according to an example embodiment.

FIG. 5 is a block flow diagram of a method, according to an example embodiment.

FIG. 6 is a logical block diagram of a system, according to an example embodiment.

FIG. 7 is a block diagram of a computing device, according to an example embodiment.

### DETAILED DESCRIPTION

Various embodiments illustrated and described herein provide include at least one of systems, methods, and software providing dashboard views of task activity data. Task activity data may be recorded and tracked with regard to activities performed within one or more systems, such as credential management system utilized to manage user identities and permissions within an organization. However, some embodiments are also relevant with regard to other systems, such as workflow systems and other systems where task performance is managed.

The embodiments illustrated and described herein, and other embodiments which will be apparent to a person of skill in the art, provide customizable visualizations of task activities and other data associated with task activities. Some embodiments provide default or administrator dashboard views, while these and other embodiments may allow individual users to customize their dashboard views. Generally, a dashboard view provides a visualization with regard to task associated data. One such example may provide a chart illustrating multiple workgroups and counts of each of a plurality of categories of task activities performed. While a dashboard view may include one chart in some embodiments, a dashboard view in other embodiments may include two, three, or more charts providing visual illustrations of task related data. These embodiments, and other, provide administrators and managers great flexibility in viewing task related data to assist in understanding performance of systems, processes, workgroups, and individual employees.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer or mobile device, partly on the user's computer or mobile device, as a stand-alone software package, partly on the user's computer or mobile device and partly on a remote computer or entirely on the remote computer or server. In the latter scenario, the remote computer may be connected to the user's computer or mobile device through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

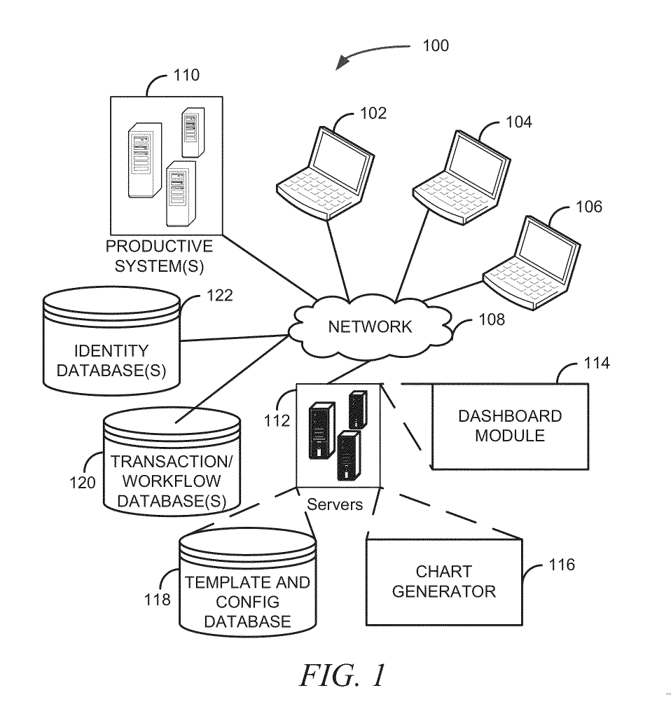

FIG. 1 is a logical block diagram of a system 100, according to an example embodiment. The system 100 includes client-computing devices 102, 104, 106 that are connected to a network 108. Also connected to the network 108 are one or more servers 112 and one or more productive systems 110. Further accessible via the network 108 in some embodiments are one or more identity databases 122 and one or more transaction or workflow databases 120.

The client-computing devices 102, 104, 106 may each be one or more types of devices, such as personal computers, laptop computers, smartphones, tablets, other mobile devices, and the like. The client-computing devices 102, 104, 106 need not all be the same type of device as in some embodiments there may be a variety of device types. The client-computing devices 102, 104, 106 are generally devices utilized by personnel that access or maintain the one or more productive systems 110. The client-computing devices 102, 104, 106 in some embodiments are devices of administrators of the one or more productive systems 110 and may perform tasks and utilize a dashboard view as presented herein. For example, a user of the client-computing device 102 may perform a configuration task with regard the one or more productive systems 110 according to an assigned task as represented in data stored in the transaction or workflow databases 120. The configuration task may include creation or modification of a user identity profile stored in the one or more identity databases 122. When the user performs the configuration task, data may be logged in the transaction or workflow database 120, such as data with regard to a productive system 110 configuration, the task performed, the user performing the task, when the task was performed, and other such data.

The network 108 is representative of one or more networks over which the various components of FIG. 1 may communicate. Thus, the network 108 may include one or more of a local area network, a wide area network, the Internet, a virtual private network, and other network types. The connections to the network may be wired or wireless and therefore may include not only wired computer networks, but also wireless data and communication networks including networks operated by mobile telephone and data carriers.

The one or more productive systems 110 are typically software systems utilized by an organization in performance of organizational business. User access privileges to the one or more productive systems 110 and roles of such users are typically assigned according identity data and defined policies associated with identities and roles. Identity data, roles, permissions, and policies are typically stored within the identity database 112. The identity database 112, although illustrated as a distinct database, may instead be a portion of one or more of the productive systems 110, or otherwise maintained thereby, depending on the productive system 110 of the particular embodiment.

The servers 112, in some embodiments, are representative of at least one server-type computer, although multiple server-type computers are utilized in some embodiments. On the servers 112 is software that executes to provide website access, although the servers 112, in some embodiments, may provide access only within a proprietary network such as a local area network. The software that executes on the servers 112 typically includes a webserver and an application server. Applications, or other units of software, that execute on the application server include a dashboard module 114 that executes to provide dashboard views of task activity data. The dashboard module 114 operates in view of the template and configuration database 118 and utilizes the chart generator 116 to generate dashboard views of the task activity data as may be retrieved from the identity databases 122 and transaction and workflow databases 120.

In one embodiment, a user, such as a manager of employees that perform tasks utilizing client-computing device 106, may request a webpage providing a dashboard view of task activities performed by employees under the manager's charge. The dashboard view request may be transmitted by the client-computing device 106 via the network 108 to the servers 112. The request will typically be received by a web server of the servers 112 and forward at least a portion of the request to the dashboard module that executes on an application server of the servers 112. The request will typically include data from which the dashboard view to be generated can be determined, such as an identifier of the particular requesting manager. Based on the data of the request, the dashboard module 114 may retrieve a dashboard view configuration from the template and configuration database 118.

The dashboard view configuration retrieved by the dashboard module includes data representative of a number of charts to include in the requested dashboard view and data to be retrieved and populated into the respective charts. The dashboard view configuration data may also include data representative of a refresh period associated with the dashboard view configuration as a whole or associated with one or more of the charts. For example, the dashboard view configuration may identify that four charts are to be included and positions within the dashboard view where each chart is to be presented. The configuration data may further identify the type of each respective chart (e.g., bar chart, pie chart, line chart, stacked cylinders, calendar, etc.), data to be included in each respective chart, and where and how the data is to be presented in the chart (e.g., along which axis, whether and how data is to be grouped, date ranges of data to be presented, etc.). As mentioned, the dashboard view configuration data may further include data representative of a refresh period data for the dashboard view or one or more of the charts included therein. The refresh period may be utilized by a server process to automatically regenerate one or more of the charts or the dashboard view as a whole and push the updated view to a viewing client. However, in other embodiments, the refresh period may be utilized by a client (i.e., a web browser, a mobile app, a thick client application, and the like) to request an update of the dashboard view as a whole or one or more of the charts included therein. The configuration data, in some embodiments, may optionally include data from which a drilldown chart may be generated. A drilldown chart is a chart that may be generated when a presented chart is selected. The drilldown chart may then present more detailed information with regard to the selected chart generally or detail with regard to a particular selected portion of a chart.

The dashboard module 114 may then process the data for each chart to be generated. The processing of each chart may include retrieval of the identified data and providing the retrieved data and chart generation parameters included in the configuration data for the respective chart to the chart generator 116. The chart generator 116 is one or more processes that execute to generate a graphical representation of data which may then be included in the requested dashboard view for visual presentation to the requesting manager, or other user. The chart generator 116 may be a software tool that generates charts based on provided parameter data identifying a type of chart and defining how data is to be presented.

The chart generator 116 may be present and execute, in whole or in part, on the servers 112. However, in other embodiments, the chart generator 116 may instead be a cloud-based service accessible via the network 108, which may include the Internet. An example of a chart generator is FusionCharts XT available from FusionCharts Technologies LLP. of Kolkata, India.

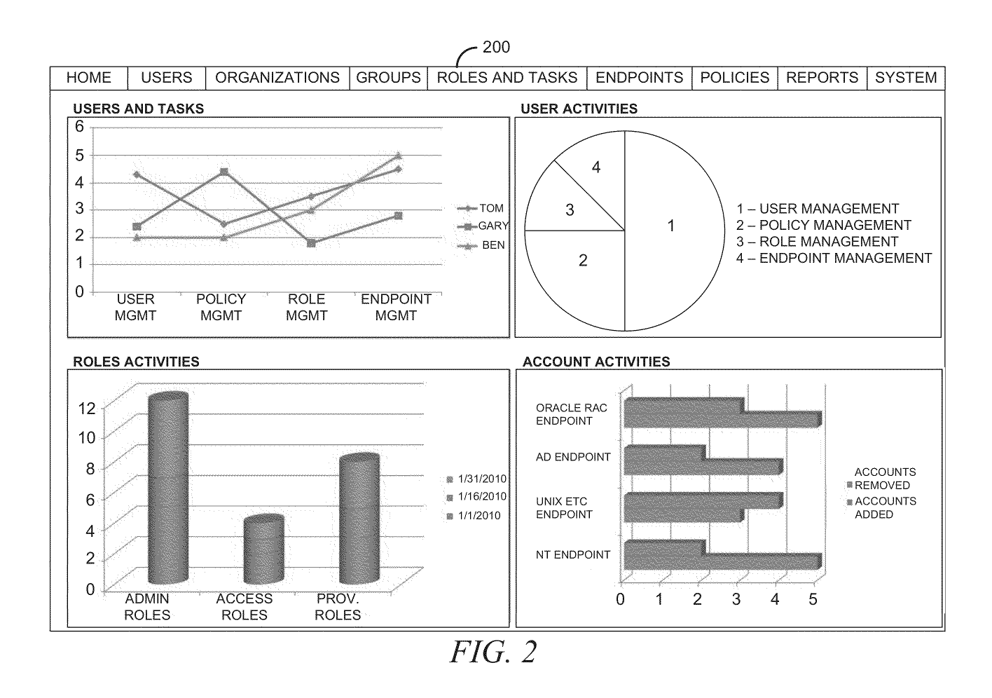

The chart generator 116, in some embodiments, may retrieve data from which to generate a chart while in other embodiments the data may be provided to the chart generator. Regardless of how the chart generator 116 receives or obtains data in a particular embodiment, the chart generator 116 processes the data in view of the chart parameters to generate a chart output. The chart output may be in the form of XML, HTML 5, an image file, an animation (i.e., a SWF file renderable by the FLASH® Player available from Adobe Systems Incorporated of San Jose, Calif.), or other type of output that is renderable by a web browser or other application or application plugin. The chart output is received by the dashboard module 114 and added to a data structure (i.e., webpage) to be transmitted back to the client-computing device 106 of the requesting manager. Once each chart of the requested dashboard view has been received by the dashboard module 114, the generated data structure will then be transmitted back to the client-computing device 106 of the manager. The client-computing device 106 may then present the dashboard view. An example of such a dashboard view is illustrated in FIG. 2.

FIG. 2 is a dashboard view 200 user interface illustration, according to an example embodiment. The dashboard view 200 is an example of a view generated based on task activity data that a manager may configure. The dashboard view 200 as illustrated includes four charts that summarize task activities performed by administrators under the charge of a manager. The USERS AND TASKS chart provides a chart view of numbers of task-types performed by particular administrators. The USER ACTIVITIES chart provides a more detailed view of task-types performed by a particular administrator named Tom. The ROLES ACTIVITIES chart provides a summary view of a number of activities performed with regard to particular role types. The ACCOUNT ACTIVITIES chart provides a summary view of account-type addition and removal activities. Fewer charts and more charts may be included in other dashboard views.

In some embodiments, the configuration of the dashboard view 200 may be a standard or default view. This view may then be modified in some embodiments according to preferences of the particular viewing user, such as a manager. The chart types, numbers, layouts, and underlying data may be modified in various embodiments. Further, the dashboard view 200 may have an automatic refresh period, the passage of which causes the dashboard view 200 to be regenerated to provide a more current view of task activities.

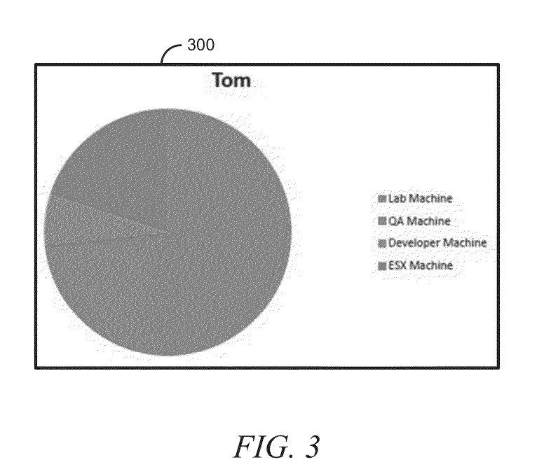

In some embodiments of the dashboard view 200, the charts may be configured to be selectable to allow a drilling down into the data underlying the chart, such as to view more detailed data or other data associated with the chart. For example, the USER ACTIVITIES chart of the dashboard view 200 may be selected to view more detailed data. In one such embodiment, one of the user activities represented in either the pie chart or the key of the USER ACTIVITIES chart may be selected to view the dashboard view 300 user interface of FIG. 3. However, in some embodiments, selection of the USER ACTIVITIES chart may cause the USER ACTIVITIES chart to be replaced within the dashboard view 200 with the chart illustrated in FIG. 3.

FIG. 3 is a dashboard view 300 user interface illustration, according to an example embodiment. The dashboard view 300 in some embodiments is a chart that may be presented when a user, such as a manager, requests a dashboard view. However, in other embodiments, the chart of the dashboard view 300 may be a chart that replaces another chart when the another chart is selected for drilling down to more detailed data, such as described in the immediately preceding paragraph with regard to the dashboard view 200 of FIG. 2.

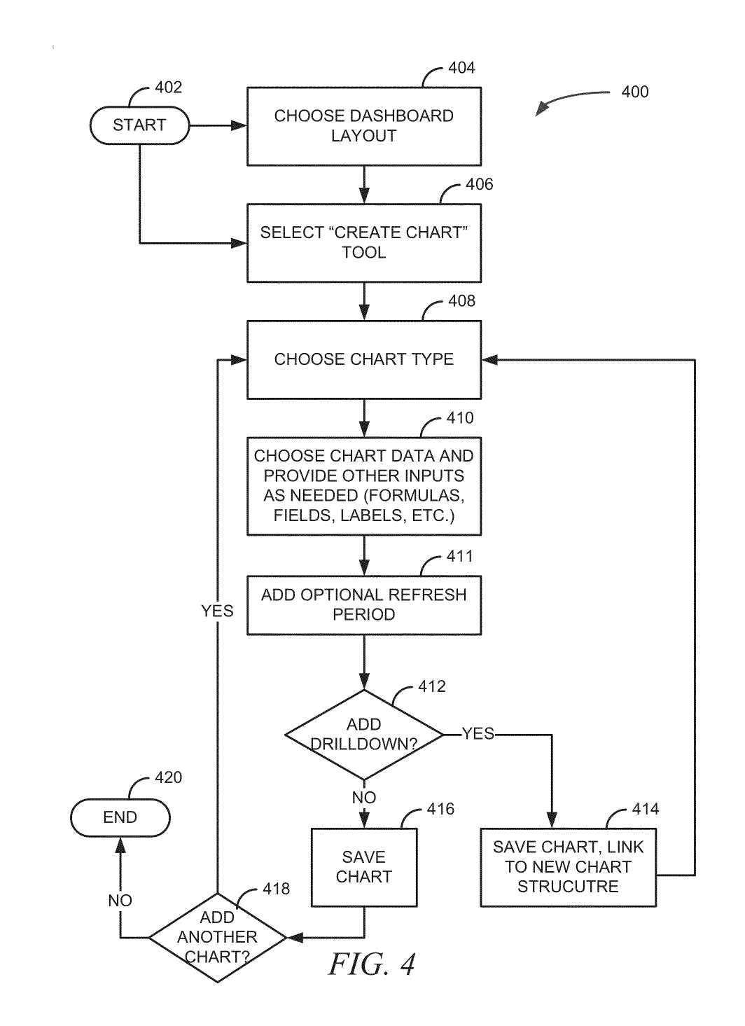

As discussed above, the dashboard view of a user, such as the dashboard view 200 of FIG. 2 and the dashboard view 300 of FIG. 3, are configurable in some embodiments. Various methods and parameters may be utilized in different embodiments to perform the configuration. FIG. 4 provides an example method that may be utilized to configure a dashboard view.

FIG. 4 is a block flow diagram of a method 400, according to an example embodiment. The method 400 starts at block 402. The first step in some embodiments is to choose 404 a dashboard layout. This may include choosing, within a dashboard view configuration user interface, a number of charts to include, chart labels, background colors, themes, fonts, a refresh period for each or all charts, and other such parameters.

However, in some embodiments, the layout may be predefined and not modifiable by a user. Further, a user may utilize the method 400 in modifying a previously configured dashboard view. In such instances, the method 400 when started 402 may first proceed selecting 406 a create chart tool.

Regardless, the user then selects 406 a create chart tool within the dashboard view configuration user interface. The create chart tool then obtains additional data from the user to configure the dashboard view. The user may be presented with options to choose 408 a chart type. Different chart type options may be presented based on chart types a chart generator, such as chart generator 116 of FIG. 1, is capable of generating. The different chart types may be numerous, such as pie charts, bar charts, maps, calendars, heat charts or maps, and other chart types. The user may then be presented with options to choose 410 chart data and to provide other inputs as needed to complete the chart. Such other inputs may include formulas, field labels, chart and axis labels, and other such data, depending on the particular embodiment, chart-types utilized, and data to be presented in the particular chart.

Some embodiments may further include an option to add 411 a refresh period for the chart. A refresh period is a period at which the chart will be automatically regenerated and represented. A refresh period need not be added in all embodiments. In some embodiments, passage of the refresh period may cause all charts within a dashboard view to be refreshed, not just the chart to which the refresh period is associated. In other embodiments, the ability to add 411 a refresh period, rather than being added in association with a particular chart may instead be added 411 in association with a dashboard configuration.

A user may then be presented with an option to add 412 a drilldown to a chart being configured. Adding 412 a drilldown associates another chart with the chart being configured. The associated chart typically will present a more detailed view of data presented in the chart being configured. However, the associated need not provide a more detailed view and instead may provide a different view of the same data, a view of other data that may be associated in some way with the chart being configured, or simply just another chart. Thus, there is great flexibility in not only configuring the charts of a dashboard view, but also in associating drilldown charts. When a drilldown chart is to be added 412, the chart being configured is saved 414, a link is added to a new chart structure to be created, and the method 400 returns to allow the user to choose 408 a chart type of the added 412 drilldown chart and the method 400 continues with regard to the drilldown chart. When there is no drilldown chart added 412, the chart being configured is saved 416.

Saving 414, 416 charts being configured causes data representative of the chart configuration to be stored, such as in the template and configuration database 118 of FIG. 1. The stored 414, 416 data is stored as or in associating with a dashboard view record of the user configuring the dashboard view and the chart(s) included therein.

Once the chart is saved 414, 416, the method 400 may then determine or ask the user if another chart is to be added 418 to the dashboard view. When another chart is to be added 418, the method 400 returns to allow the user to choose 408 a chart type of the added 418 chart and the method 400 continues with regard to the added 418 chart. When another chart is not to be added 418, the method 400 ends 420.

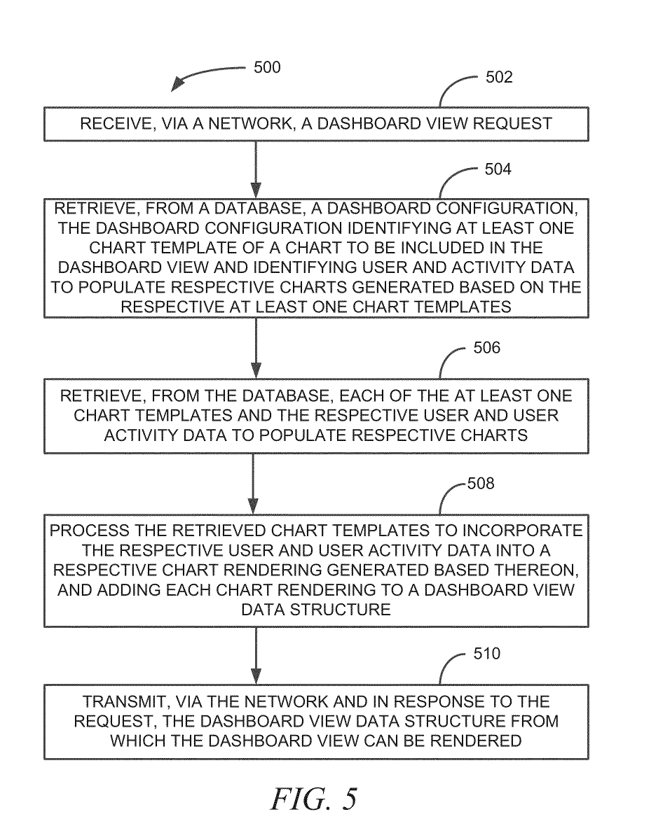

FIG. 5 is a block flow diagram of a method 500, according to an example embodiment. The method 500 is an example method of receiving, processing, and responding to a dashboard view request, such as may be performed in whole or in part by the dashboard module 114 of FIG. 1.

The method 500 includes receiving 502, via a network, a dashboard view request. In response the received 502 dashboard view request, the method 500 retrieves 504, from a database, a dashboard configuration. The dashboard configuration in some embodiments is specific to the user. Thus, when the request is received 502, the requesting user is identified, such as through a user identifier included in the request, a user identifier associated with a network session within which the request was received, or in another manner. A dashboard configuration typically identifies at least one chart template of a chart to be included in the dashboard view and identifies user and activity data to populate respective charts generated based on the respective at least one chart templates. In some embodiments, a chart template is a data structure populated with configuration data from which a chart can be generated. Such chart templates may be utilized and generated in the method 400 described above with regard to FIG. 4.

Based on the retrieved 504 dashboard configuration, the method 500, in some embodiments, may further retrieve 506, from the database, each of the at least one chart templates and the respective user and user activity data to populate respective charts. The method 500 may then process 508 the retrieved chart templates to incorporate the respective user and user activity data into a respective chart rendering generated based thereon, and adding each chart rendering to a dashboard view data structure. The processing 508 may include invoking a data visualization module, such as chart generator 116 of FIG. 1, to generate the chart renderings. The dashboard view data structure may then be transmitted 510, via the network and in response to the received 502 request. The dashboard view data structure generally includes data from which the dashboard view can be rendered. For example, the dashboard view data structure may include one or more of image files, markup language data from which chart renderings may be made, one or more animation files, and other such data.

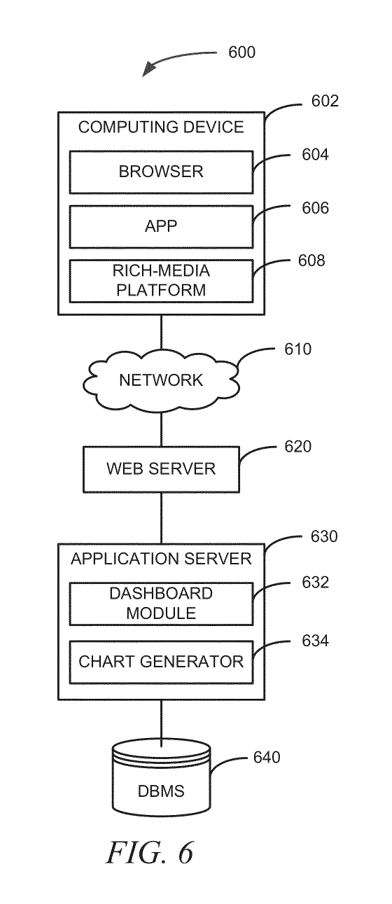

FIG. 6 is a logical block diagram of a system 600, according to an example embodiment. The system 600 provides a different perspective of a computing environment within which some embodiments may be implemented. The system 600 includes a computing device 602 communicatively coupled to a network 610. Also communicatively coupled to the network is a web server 620. Behind the web server 620 is an application server 630 that can access data managed and stored by at least one database management system 640 (DBMS).

The computing device 602 can be one of any number of computing device types. For example, computing device 602 may be a personal computer, tablet device, smartphone, handheld computer, set top box or smart television, or other device including computing and network capabilities. The computing device 602 may include one or more software mechanisms through which dashboard views may be configured and viewed. Such software mechanisms may include a web browser 604 application, a device app 606, a rich media platform 608 such as the FLASH® player or other software element within which interactive media may be presented, and other software mechanisms.

The application server 630 includes at least a dashboard module 632, such as the dashboard module 114 of FIG. 1, and a chart generator 634, such as chart generator 116 of FIG. 1. Functionality of the dashboard module 632 may be accessed by the computing device 602, such as through the browser 604, via the network 610. The dashboard module 632 in concert with the chart generator 634 services dashboard view requests and dashboard configuration submissions. The dashboard module 632 and chart generator 624 may generate dashboard views based in part on data stored in one or more other systems or system components, which are not illustrated.

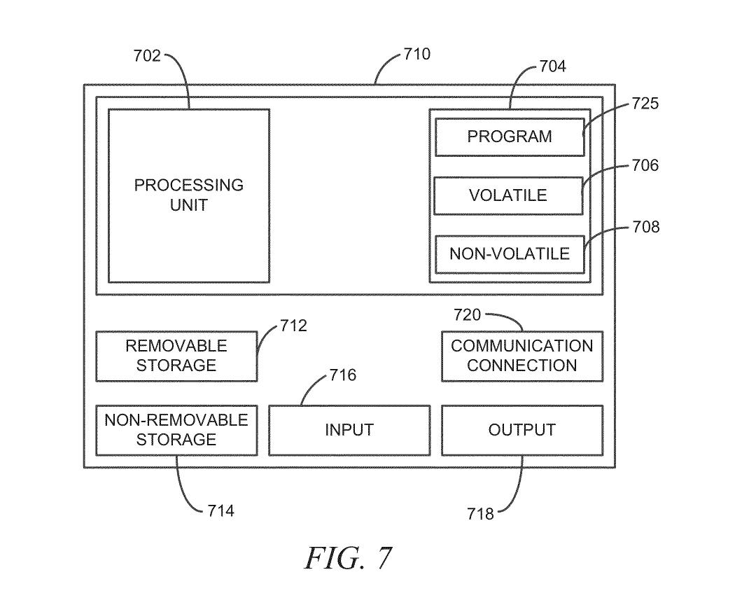

FIG. 7 is a block diagram of a computing device, according to an example embodiment. The computing device illustrated in FIG. 7 is an example of a computing device that may be implemented as one or more of the computing device 602, the application server 630, or web server 620 as illustrated in FIG. 6. In one embodiment, multiple such computer systems are utilized in a distributed networked computing environment, such as in the system 600 of FIG. 6, to implement multiple components in a transaction-based environment. An object-oriented, service-oriented, or other architecture may be used to implement such functions and communicate between the multiple systems and components. One example computing device in the form of a computer 710, may include a processing unit 702, memory 704, removable storage 712, and non-removable storage 714. Memory 704 may include volatile memory 706 and non-volatile memory 708. Computer 710 may include—or have access to a computing environment that includes—a variety of computer-readable media, such as volatile memory 706 and non-volatile memory 708, removable storage 712 and non-removable storage 714. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 710 may include or have access to a computing environment that includes input 716, output 718, and a communication connection 720. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 702 of the computer 710. A hard drive, CD-ROM, and RAM are some examples of articles including a non-transitory computer-readable medium. For example, a computer program 725 capable of performing one or more of the methods, or portions thereof, illustrated and described herein.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, via a network, a dashboard view request;
retrieving, from a database, a dashboard configuration, the dashboard configuration identifying a chart template of a chart to be included in the dashboard view and identifying user and activity data to populate the chart generated based on the chart template;
retrieving, from the database, the chart template and the user and corresponding user activity data;
processing the retrieved chart template to incorporate the user and corresponding user activity data into a chart rendering generated based thereon, and adding the chart rendering to a dashboard view data structure; and
transmitting, via the network and in response to the request, the dashboard view data structure from which the dashboard view can be rendered.

2. The method of claim 1, wherein the dashboard configuration is retrieved based at least in part on a user identity associated with the dashboard view request.

3. The method of claim 1, wherein the retrieving of the chart template and the user and user activity data to populate the chart template and the processing comprises invoking a data visualization module to generate the chart rendering.

4. The method of claim 1, wherein the user and user activity data is data representative of task activities performed by users.

5. The method of claim 1, wherein the dashboard configuration comprises a refresh parameter that is represented in the dashboard view data structure to cause a viewing client to automatically submit a further dashboard view request to update a rendering the chart included in the dashboard view data structure.

6. The method of claim 1, wherein a data item represented in the chart rendering is selectable within a rendering generated from the dashboard view data structure to submit a request, via the network, for a further dashboard view based at least in part on the data item.

7. The method of claim 1, further comprising:
receiving dashboard view configuration input defining a parameter of a chart to be included in dashboard views of a user;
updating a dashboard view configuration in the database associated with the user to include a representation of the configuration input; and
processing subsequent dashboard view requests received with regard to the user based in part on the updated dashboard view configuration associated with the user.

8. A computer program product comprising:
a computer readable storage medium having computer readable program code embodied therewith, the computer program code comprising:
computer readable program code configured to receive, via a network, a dashboard view request;
computer readable program code configured to retrieve, from a database, a dashboard configuration, the dashboard configuration identifying a chart template of a chart to be included in the dashboard view and identifying user and activity data to populate the chart generated based on the chart template;
computer readable program code configured to retrieve, from the database, the chart template and the user and corresponding user activity data;
computer readable program code configured to process the retrieved chart template to incorporate the user and user activity data into a chart rendering generated based thereon, and add the chart rendering to a dashboard view data structure; and
computer readable program code configured to transmit, via the network and in response to the request, the dashboard view data structure from which the dashboard view can be rendered.

9. The computer program product of claim 8, wherein the dashboard configuration is retrieved based in part on a user identity associated with the dashboard view request.

10. The computer program product of claim 8, wherein the retrieving of the chart template and the user and user activity data to populate the chart and the processing comprises invoking a data visualization module that generates the chart rendering.

11. The computer program product of claim 8, wherein the user and user activity data is data representative of task activities performed by users.

12. The computer program product of claim 8, wherein the dashboard configuration comprises a refresh parameter that is represented in the dashboard view data structure to cause a viewing client to automatically submit a further dashboard view request to update a rendering based on the chart included in the dashboard view data structure.

13. The computer program product of claim 8, wherein a data item represented in a chart rendering is selectable within a rendering generated from the dashboard view data structure to submit a request, via the network, for a further dashboard view based on the data item.

14. The computer program product of claim 8, with further computer readable program code embodied therewith, the further computer readable program code comprising:
computer readable program code configured to receive dashboard view configuration input defining a parameter of a chart to be included in dashboard views a user;
computer readable program code configured to update a dashboard view configuration in the database associated with the user to include a representation of the configuration input; and
computer readable program code configured to process subsequent dashboard view requests received with regard to the user based on the updated dashboard view configuration associated with the user.

15. A system comprising:
a processor, a memory device, and a network interface device; and
an instruction set of a computer program product stored on the memory device, the instructions executable by the processor to cause the system to:
receive, via the network interface device, a dashboard view request;
retrieve, from a database, a dashboard configuration identifying a chart template of a chart to be included in the dashboard view and identifying user and activity data to populate a chart generated based on the chart template;
retrieve, from the database, a chart template and the user and user activity data;
process the retrieved chart template to incorporate the user and corresponding user activity data into a chart rendering generated based thereon, and add the chart rendering to a dashboard view data structure; and
transmit, via the network interface device and in response to the request, the dashboard view data structure from which the dashboard view can be rendered.

16. The system of claim 15, wherein the dashboard configuration is retrieved based in part on a user identity associated with the dashboard view request.

17. The system of claim 15, wherein the retrieving of the chart template and the user and user activity data to populate the chart and the processing comprises invoking a data visualization module executable by the processor to generate the chart rendering.

18. The system of claim 15, wherein the dashboard configuration comprises a refresh parameter that is represented in the dashboard view data structure to cause a viewing client to submit a further dashboard view request to update a rendering of the chart included in the dashboard view data structure.

19. The system of claim 15, wherein a data item represented in a chart rendering is selectable within a rendering generated from the dashboard view data structure to automatically submit a request, via the network interface device, for a further dashboard view based on the data item.

20. The system of claim 15, wherein the instructions of the computer program product stored on the memory device are further executable by the processor to cause the system to:
receive dashboard view configuration input defining a parameter of a chart to be included in dashboard views of a user;
update a dashboard view configuration in the database associated with the user to include a representation of the configuration input; and
process subsequent dashboard view requests received with regard to the user based on the updated dashboard view configuration associated with the user.
